(19) United States
(12) Patent Application Publication
(10) Pub. No.: US 2019/0186474 A1
(43) Pub. Date: Jun. 20, 2019

(54) FLOATING DEVICE COMPRISING AN INTERCHANGEABLE INSERT PASSING THROUGH A FLOAT AND ASSOCIATED ELECTRICAL PRODUCTION SYSTEM

(71) Applicant: Bardot Group, La Ciotat (FR)

(72) Inventors: Pierre GUERIN, Toulon (FR); Guillaume GROS, Cassis (FR)

(73) Assignee: Bardot Group, La Ciotat (FR)

(21) Appl. No.: 16/327,909

(22) PCT Filed: Mar. 31, 2017
(86) PCT No.: PCT/FR2017/050753

§ 371 Date: Feb. 25, 2019

Related U.S. Application Data
(60) Provisional application No. 62/379,540, filed on Aug. 25, 2016.

(51) Int. Cl. F03G 7/05; F16L 1/15; B63B 35/44

(52) U.S. Cl. CPC F03G 7/05; B63B 2035/4433; B63B 35/44; F16L 1/15

(57) ABSTRACT

The invention concerns a floating device for cooperating with an insert via a reversible interlocking connection, comprising a float and having a main hole. In order to propose a floating device adaptable to a very large number of applications, proposing, in particular, an optional multi-step installation, the main hole of such a device is arranged to receive the insert. Moreover, the floating device comprises reversible attachment structure arranged to maintain a relative position of the device along the insert. The invention further concerns a floating system comprising a floating device according to the invention and an insert cooperating with the floating device via a reversible interlocking connection, the insert being designed to produce electrical energy by means of the thermal gradient of the oceans.

The invention relates to the field of energy production devices and systems, preferably but not limited to electrical energy, using in particular technologies based on ocean thermal energy (also known by the abbreviation “OTEC”—Ocean Thermal Energy Conversion). Said technologies are used for all types of application and preferably for, but not limited to, those in the ocean, implemented together with the supply of energy for isolated sites, such as an offshore production or drilling site in tropical regions.

Nowadays, petroleum, natural mineral oil and mineral oil mixed with hydrocarbons is freely exploited and is thus central to everyday life and therefore central to the global economy. Moreover, this fossil energy source is referred to as “black gold” for good reason. Indeed, petroleum:
provides most liquid fuels, such as, by way of non-limiting example, LPG, fuel oil, gas oil, kerosene, petrol;
forms the basis of many everyday objects, such as, by way of non-limiting example, textiles, cosmetics, fertilizers, detergents, etc., in the form of naphtha when produced by means of refining and then converted by means of petrochemistry;
is also a constituent of, inter alia, bitmens, lubricants and paraffins.

Moreover, petroleum has numerous advantages because, as a liquid energy source, it is easy to pump, store, transport and use. Furthermore, it has a high energy density. However, like any fossil fuel, petroleum is a non-renewable energy source since it requires millions of years to form and the petroleum resources are being depleted more quickly than they are being produced. Finally, petroleum and other fossil fuels are not considered to be green energy sources because the use thereof has a direct or indirect impact on the environment. Indeed, at establishment sites, for example in the immediate vicinity of a hotel, in particular for completely autonomous production of electricity, generator units may be used. Units of this kind are, however, unfavorable to carry out because they require an expensive and unclean supply of fossil fuels. In a variant or in addition, other electrical energy production devices and/or systems are used, exploiting solar energy for example. Although less polluting, devices and/or systems of this kind are nonetheless associated with some drawbacks because the proper operation thereof is dependent on the sunlight.

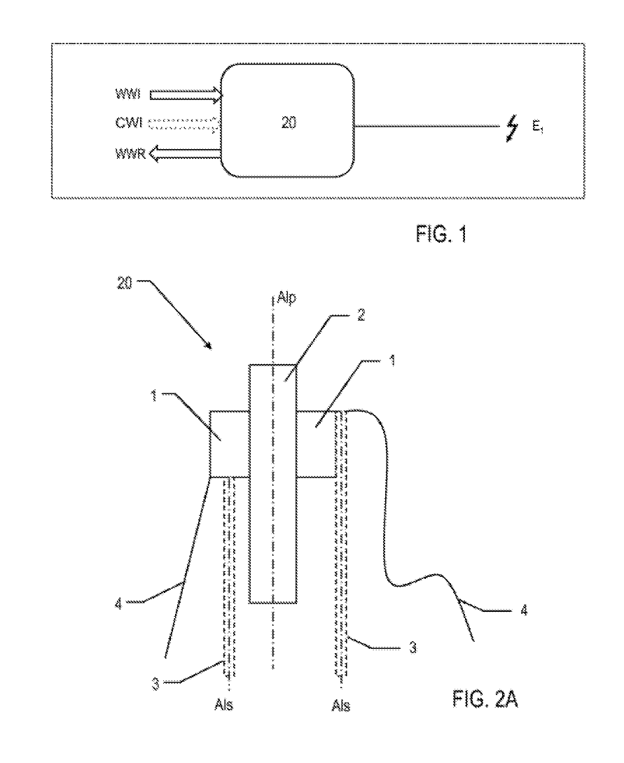

In order to overcome drawbacks of this kind, it has been necessary to seek solutions based on resources that are virtually inexhaustible and are present on Earth. Owing to the extent thereof on Earth, oceans and seas act as vast solar radiation collectors that allow for heating of the upper regions of said oceans and said seas. Said upper regions referred to as “warm” do not mix with the lower regions referred to as “cold” which are present at greater depth. Indeed, the density of the water increases when the temperature thereof decreases. On the basis of this temperature difference, energy production systems, such as, by way of example, electricity production systems, have subsequently been developed by using technologies based on OTEC. FIG. 1 schematically illustrates the operation of an electrical energy production system based on known OTEC technologies. An electrical energy E1 production system 20 of this kind is advantageously supplied with cold water and warm water, respectively, via a cold water intake CWI and a warm water intake WWI that draw deep seawater and surface seawater in order to ultimately provide electrical energy E₁.

Nonetheless, thermal electrical energy production systems of this kind can generally be used only in intertropical regions, in order to achieve a sufficient production yield. Indeed, said yield is dependent on the temperature difference between the warm water and cold water sources, it being necessary for said difference to be in the order of twenty degrees Celsius in order to operate in a optimal manner. In addition to producing electrical energy, systems of this kind may also make it possible to generate other forms of “energy” that can be used for example to cool air in a room or to irrigate agricultural land.

In terms of design, the OTEC systems produce energy by means of an operating fluid being present, for example ammonia, seawater or any other fluid of which the condensation point corresponds to a temperature close to four degrees Celsius. An OTEC system of this kind generally comprises an evaporator, inside which said operating fluid is vaporized in contact with warm water previously drawn to the surface. Once vaporized, an operating fluid of this kind is conveyed inside a turbine in order to rotate said turbine and to finally produce electricity. Subsequently, in order to be re-condensed, the operating fluid is conveyed to a condenser included the system, this time in contact with cold water previously drawn from deep in the ocean. Although systems using OTEC technologies generally comprise the same elements, said systems may operate in accordance with different cycles or embodiments.

According to a first embodiment, an OTEC system may operate in an open cycle: the warm seawater is advantageously and directly used for producing electricity. Indeed, said warm water is first pumped into a tank at low pressure or under vacuum, said tank then allowing for said warm water to be vaporized. The water vapor is thus pure. Said vapor is then conveyed to a turbine which it rotates, said turbine being connected to an electrical generator. The vapor is then introduced into a condenser, while being exposed to cold seawater from deep in the ocean, in order to return to its liquid state. Said water, ultimately produced in liquid form, can advantageously be used as drinking water, for irrigation, or for aquaculture. Nonetheless, electrical energy production systems implementing open-cycle operation have drawbacks: firstly, since the cycle is open it is often difficult to achieve a complete vacuum within the system, generally reducing the operating efficiency of an open cycle of this kind. In addition, the low pressure prevailing within the system makes it necessary to use a large-size turbine, resulting in costs and in laborious and complex manufacturing, installation and maintenance processes.

According to a second embodiment, an OTEC system may operate in a closed cycle, usually modelled by an “Organic Rankine Cycle-ORC.” In this case, an OTEC electrical energy production system of this kind firstly comprises an evaporator inside which warm water, previously pumped to the surface, circulates. The warm water thus makes it possible to vaporize an operating fluid that advantageously has a low boiling point. This is the case, for example, for ammonia. Said OTEC system then comprises a turbine into which the vaporized operating fluid passes. Said turbine is thus supplied with the vaporized operating fluid in order to itself drive an electricity generator connected thereto. The gaseous operating fluid expands in the turbine. The pressure of said fluid is therefore lower at the output of the turbine. The OTEC system then comprises a condenser that allows for said operating fluid to be condensed, said condenser causing cold seawater to flow in the interior thereof in order to allow for condensation of this kind. The liquid operating fluid is then conveyed by means of a circulation system, for example a pump, in order to again supply the evaporator and to thus allow for the cycle to be repeated.

According to a third embodiment, an OTEC system may operate in a hybrid cycle. A hybrid cycle of this kind combines the features of the open-cycle and closed-cycle systems. In this design, an OTEC electrical energy production system comprises a chamber under vacuum, inside which salt water is introduced and vaporized very quickly, in the manner of the evaporation process within the open cycle. The water vapor in turn vaporizes an operating fluid, such as ammonia, that is present within a circuit of a closed cycle and is located opposite the operating fluid vaporizer. Said operating fluid, thus vaporized, drives a turbine which in turn starts up an electricity generator. Although it makes it possible to take advantage of the open and closed electrical energy production cycles, respectively, described above, said hybrid cycle is associated with other drawbacks, in particular investment, installation and maintenance costs because twice the materials are required for implementing a hybrid cycle of this kind. Moreover, owing to a significant “return” of cold water to the surface, using said hybrid cycle results in a greater phenomenon of cooling of surface water, which may be damaging for flora and fauna.

Establishing OTEC systems or facilities has been found to be essential for implementing systems or facilities of this kind. Indeed, since the OTEC systems that are based on a temperature gradient of at least twenty degrees Celsius established between warm water at the surface and cold water deep in the ocean, they generally require access to said water resources in tropical regions, i.e. they have to be installed close to or in the seas or oceans. Nowadays, a distinction is made between two types of OTEC system infrastructure, specifically land-based or floating systems. The land-based systems, generally installed in the form of one or more buildings, are located on the waterfronts or close to bodies of water. Land-based systems of this kind have the advantage of not requiring sophisticated mooring systems, endless feeder cables, and intensive maintenance owing to the installation thereof offshore. Furthermore, land-based systems of this kind can advantageously be positioned in sheltered and possible protected regions. Nonetheless, land-based systems of this kind still face problems of coastal erosion and significant damage from possible hurricanes and other storms. Furthermore, the efficiency and the yield thereof have been found to be limited owing to the difficulty in achieving a temperature gradient that is sufficient for optimal operation. Indeed, the cold water used in the systems is primarily drawn from water deep in the sea, in the region of a thousand meters deep. In addition, said devices require very long pipes to be used to draw the cold water, pipes of this kind being susceptible to material failures, as well as having particularly high manufacturing and installation costs. As a result, in some cases, in particular in order to easily draw cold water, to take advantage of a greater temperature gradient, and thus to generate electricity more efficiently, floating systems are preferable thereto. Said floating systems operate in a manner similar to the land-based systems, being based on the use of a temperature gradient between warm water and cold water. As a result, since the floating systems are located directly offshore, it is easy to convey cold water directly to the center of the system, because one or more pipes are positioned vertically, facilitating installation and maintenance of said pipe or pipes.

Furthermore, it is also easy to convey warm water, because the warm water drawn at the surface is located close to the floating systems.

Nonetheless, within the context of the development of floating systems focused on OTEC technologies, one of the frequent problems is that of the installation and maintenance of the central technology. Indeed, the floating systems currently used are generally specifically focused on OTEC technologies and are installed on-site as “all-inclusive” systems. The installation and the maintenance of floating systems of this kind is thus associated with a number of drawbacks, in particular significant bulk during transport and complete replacement of the installation, deploying a large number of professionals and a large amount of equipment directly on-site in order to manage, for example, possible mooring restrictions of the floating system, in particular mechanical, fluidic or even electrical restrictions, consequently leading to exponential costs for said operations.

The invention makes it possible to overcome all or some of the drawbacks that arise in the known solutions.

Among the numerous advantages provided by a floating device according to the invention, it should be noted that said device makes it possible to:
facilitate and improve the installation and optionally the maintenance of floating systems installed offshore, such as electrical energy production systems of the OTEC type;
proposing a modular floating device that can be adapted for a very large number of technological applications, by proposing in particular a multi-step installation, such as the use of a plurality of floaters independently of the system or systems per se which ultimately cooperate with said floater or floaters;
reducing the amount of equipment and number of devices used, facilitating the installation and maintenance by using pre-assembled devices, and consequently thereby simultaneously reducing the installation and maintenance costs by reducing the number of professionals and the amount of equipment required;
ensuring a significant saving in installation and maintenance time and, as a result, a significant reduction in costs.

For this purpose, the invention in particular proposes a floating device for cooperating with an insert by means of a reversible fitted connection, comprising a floater and having a main port. In order to propose a modular floating device that can be adapted for a very large number of technological applications, and to reduce the amount of equipment and number of devices used, the main port of a floating device according to the invention is arranged so as to receive said insert, said main port having a cross section that is larger than or substantially equal to the cross section of the outer wall of the casing of a portion of said insert and having a longitudinal axis that is substantially perpendicular to the waterline of said device once said device is in the water. A floating device of this kind furthermore comprises reversible fixing means that are arranged so as to maintain a relative position of said device along the insert.

Advantageously, in order to ensure lasting installation of a floating device according to the invention, the casing or the structure of said floater may be formed primarily of steel and/or polymer.

In a variant or in addition, the floater of a floating device according to the invention may be formed of a plurality of separate elements that cooperate, respectively, in pairs, by means of a mechanical connection of the fitted type.

In order to ensure lasting on-site flotation of a floating device according to the invention, the floater thereof may be formed of a plurality of compartments that cooperate, respectively, in pairs, in accordance with a fitted connection.

In order to protect the structure of a floating device according to the invention from possible impacts, the casing of said device may have a skirt-type structure.

Preferably, but in a non-limiting manner, the fixing means of a floating device according to the invention may make use of bolts.

In a variant or in addition, when the application implemented by a floating system according to the invention requires the use of fluid pipes for the operation thereof, a floating device according to the invention may also comprise a secondary port that has an axis that is substantially in parallel with the longitudinal axis of the main port and is arranged so as to accommodate a water pipe.

Advantageously but in a non-limiting manner, in order to prevent drifting of a floating device 1 according to the invention and to ensure lasting installation and operability thereof, said floating device may furthermore comprise or cooperate with anchoring means.

Preferably, but in a non-limiting manner, the anchoring means may comprise at least one mooring line.

According to a second object, the invention relates to a floating system comprising a floating device according to the invention and an insert that cooperates with said floating device by means of a reversible fitted connection. According to a preferred but non-limiting application, the insert of a floating system according to the invention is advantageously designed to produce electrical energy using a temperature gradient of the oceans.

In order to implement the production of electrical energy, preferably but in a non-limiting manner the insert of a floating system according to the invention may comprise:
first and second supply circuits for warm water and cold water, respectively;
a supply circuit for operating fluid;
first and second heat exchangers that cooperate fluidically with said first and second supply circuits for warm water and cold water, respectively, and with said supply circuit for operating fluid;
a turbine that cooperates fluidically with the first and second heat exchangers;
an electricity generator that cooperates with said turbine by means of a mechanical connection.

In a variant or in addition, advantageously but in a non-limiting manner, when a floating device according to the invention comprises one or more secondary ports, the first and secondary port supply circuits for warm water and cold water, respectively, for the insert of a floating system according to the invention may comprise water pipes, at least one of said pipes being accommodated inside the secondary port of said floating device.

Other features and advantages will emerge more clearly from reading the following description and from the accompanying drawings, in which:

FIG. 1, described above, schematically illustrates the operation of an electrical energy production system based on known OTEC technologies;

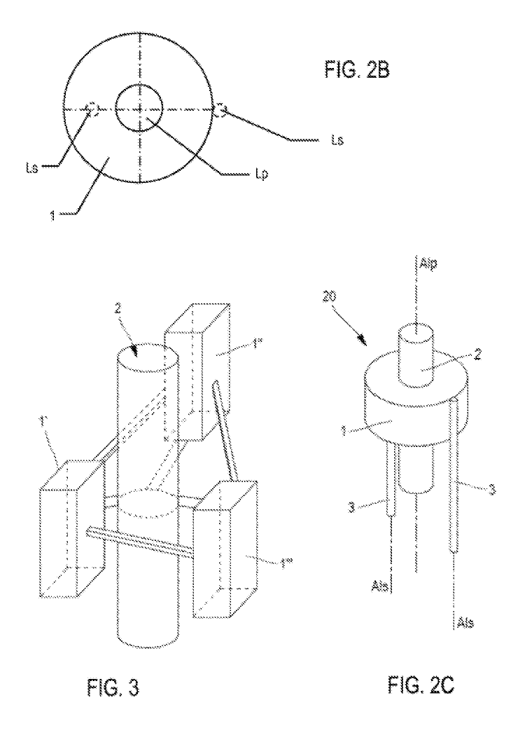

FIGS. 2A, 2B and 2C show a first embodiment of a floating device and floating system according to the invention;

FIG. 3 schematically shows a second embodiment of a floating device according to the invention;

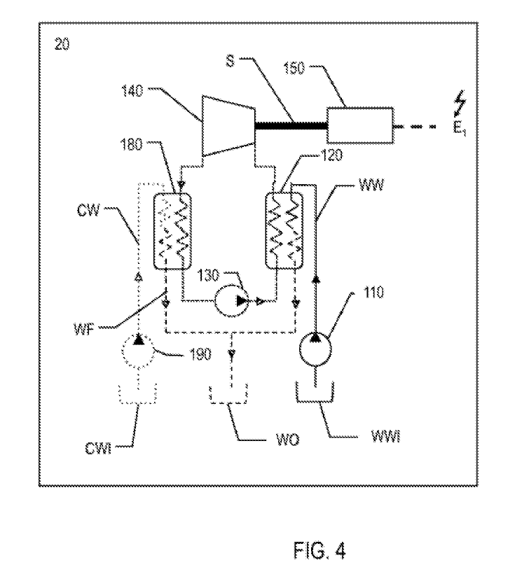

FIG. 4 schematically shows a non-limiting example of the structure of the insert of a floating system according to the invention, said system advantageously being arranged so as to produce electrical energy.

FIGS. 2A, 2B and 2C schematically show a first embodiment of a floating device and floating system according to the invention. FIG. 3 schematically shows a second embodiment of a floating system according to the invention, the arrangement of which differs on account of the structure of the floating device. However, the invention is not limited to just these embodiments.

According to a first preferred use, a floating system according to the invention may consist in generating electrical energy form the temperature gradient of the oceans. A system of this kind may advantageously be formed of various sub-systems such as, but not exclusively, a floating device that optionally comprises or cooperates, by means of any mechanical connection, with an anchoring system, and means for intake and discharge water, a technological sub-system or insert that is arranged so as to generate electrical energy, and a sub-system for conveying the electricity thus produced to a storage unit or to one or more facilities that require electrical energy.

An electrical energy production system 20 of this kind preferably uses OTEC technologies, consisting primarily in methods using a temperature gradient that exists between cold deep seawater and tropical warm surface seawater, in order to produce electricity without carbon emissions. At present, in order to operate optimally, the electrical energy production systems require a temperature gradient of approximately twenty degrees Celsius between the pumped cold water and warm water. As a result, in order to obtain a source of cold water at temperatures in the range of five to six degrees Celsius, it is necessary at present for the cold water to be pumped at depths in the range of a thousand meters deep. Nonetheless, the progression of technological advances makes it possible to reduce said temperature gradient and to thus draw cold water at less significant depths. In this case, the electrical energy production system according to the invention can advantageously be adaptable and/or adapted.

According to a first object of the invention, said invention relates to a floating device for cooperating with an insert, also denoted “process,” by means of an advantageously reversible fitted connection. Within the meaning of the invention and throughout the entire document, “insert” is intended to mean any structure or system comprising the technological core, i.e. comprising the elements or materials necessary for carrying out the desired application. An insert of this kind may also be referred to as an “exchangeable column.” As already specified, by way of non-limiting example said floating device is advantageously suitable for being used in conjunction with an insert, in the form of a system for generating electrical energy from a temperature gradient, also referred to as heat transfer, observed between deep waters and surface waters in the sea. However, the invention is not limited to this single embodiment.

FIGS. 2A, 2B, 2C and 3 show two embodiments of a floating device of this kind. Said floating device 1 firstly comprises a main port Lp. Within the meaning of the invention and throughout the document, “port” is intended to mean any central opening, recess or cavity that is arranged in the floating device in order to allow for an insert 2 to pass, indeed to be retained, therein. As a result, the main port Lp is arranged so as to receive said insert, i.e. in the case of this preferred embodiment but in a non-limiting manner a system for generating electrical energy, which insert can be positioned inside said floating device offshore once said floating device has already been installed on-site, i.e. optionally anchored offshore. The insert can thus be denoted as “exchangeable.” Indeed, any other insert may instead be introduced into said floating device, depending on the desired application or services. For this purpose, it is sufficient for the structural and/or functional arrangement to be matched primarily to the design of the main port accommodated in said floating device. As a result, said main port Lp advantageously has a cross section of dimensions that are substantially greater than or equal to those of the cross section of the portion of the outer wall of the casing of said insert 2 that passes through said floating device 1. Furthermore, said cross section may advantageously be square, circular, oblong or of any other shape that can be adapted to the outer wall of the casing or of an insert, the portion of which slides or passes through the main port Lp, or optionally even a plurality of inserts. By way of preferred but non-limiting example, as described with reference to FIGS. 2A to 2C and 3, such an outer wall of the casing of the insert may have a substantially cylindrical cross section. As a result, the port Lp may also have a substantially circular cross section similar to that of the outer wall of the insert 2. By way of non-limiting example, a main port Lp, also referred to as a “central well” may, if in a central position of the longitudinal axis Alp that is substantially perpendicular to the waterline of the device, advantageously have a diameter of between two meters and fifteen meters, if the cross section of said main port is advantageously cylindrical. Nonetheless, the invention is not limited to just one single main port Lp being provided. Indeed, it may be possible, according to the invention, for a floating device according to the invention to comprise a plurality of main ports Lp of the same or different dimensions or designs, which ports are arranged so as to optionally receive a plurality of identical or different inserts.

Said main port Lp also has a longitudinal axis Alp. Throughout the document, “longitudinal axis of the main port” is intended to mean any axis passing through the floating device in the direction of the length thereof. Regarding the design of the floating device 1, as described with reference to FIGS. 2A to 2C and 3, a longitudinal axis Alp that passes through said device is substantially in parallel with the longitudinal axis of an insert 2, said insert being enclosed by said device. By way of non-limiting example, when the main port Lp has a circular and constant cross section, as described with reference to FIG. 2A to 2C, the longitudinal axis Alp may be substantially in parallel with, indeed may even coincide with, the axis of revolution of the main port Lp. Furthermore, since a device floating 1 according to the invention is advantageously installed and maintained offshore, the longitudinal axis Alp thereof is advantageously defined as being substantially perpendicular to the waterline of said floating device 1.

Furthermore, said floating device 1 according to the invention advantageously comprises a floater, i.e. an integral or multi-part body, or more generally any flotation means, that is designed or suitable for floating on the surface of the water and supporting or keeping a portion or the entirety of the insert 2 at the surface, an insert 2 of this kind generally being a submersible body. By way of non-limiting example, the casing or, more generally, the structure, i.e. the body, of a floater of this kind may in principle preferably be formed of steel and/or polymer(s). The floater may also be arranged such the draft of said floater, and more generally of said floating device, remains limited after said floating device 1 has been placed in the water. Preferably, but in a non-limiting manner, the structure of the floater may be designed such that the draft remains less than five meters. According to FIG. 2A to 2C, the casing of the float of a floating device 1 according to the invention may advantageously be substantially cylindrical in shape. Nonetheless, the invention is not limited to just this embodiment. In a variant (not shown in the drawings), the floater may advantageously be defined by a polyhedral shape, defining for example a square or triangular cross section, or any other cross section capable of being adapted to said floating device 1. The casing of the floater of a floating device 1 of this kind may also comprise a plurality of faces. A multi-face design of this kind makes it possible in particular to improve the stability of said floating device, having a particular hydrodynamic profile that has the smallest possible impact on the stability of the floating system 20 comprising the floating device 1 cooperating with the insert 2. According to a preferred but non-limiting embodiment, described in particular with reference to FIG. 2A to 2C, the floater may be similar to a cylinder. According to this advantageous embodiment, the outside diameter of the cross section of the floater may advantageously be selected so as to be between ten meters and thirty meters, and the height of said cylinder may be between six and twenty meters. Nonetheless, the invention is not limited to just these value ranges or to this circular design, and generally depends on the desired application or services.

As has been described, the floater of a floating device 1 according to the invention may in principle be an integral body, optionally formed of one or more independent, sealed compartments. In a variant or in addition, according to a second embodiment described in particular with reference to FIG. 3, the floater may advantageously be formed of a plurality of separate elements that cooperate, respectively, in pairs, by means of a mechanical connection of the fitted type. According to FIG. 3, the floater of a floating device 1 according to the invention may, advantageously but in a non-limiting manner, comprise three elements 1′, 1″, 1′″ that are separate and rigidly connected, in pairs, by means of suitable mechanical connections. As a result, a floater, in the form of a plurality of separate elements, makes it possible to restrict the intrinsic volume of said floater depending on the size of the surface for receiving an insert.

In a variant or in addition (not shown in the drawings), as already mentioned, the element or elements of a floater of this kind, whether integral or in multiple parts, may consist of a plurality of compartments that are separated by radial partitions. A configuration of this kind, by means of a plurality of compartments, in particular allows the floater, whether this be formed by one element or by a plurality of elements, and finally the floating device, to carry out its function, even if one of the compartments may possibly experience a leak or other damage and can thus no longer carry out its function.

Furthermore, in a variant or in addition, the casing of the element or elements of said floater may comprise a skirt-type structure that surrounds said casing. A skirt structure of this kind may optionally be formed primarily of steel or polymer. The presence of said skirt is particularly expedient because it makes it possible not only to protect the structure from possible impacts, but also to improve the hydrodynamic profile of the floating device according to the invention, by emphasing roll or pitch attenuations which a floating device 1 according to the invention may possibly experience.

In order to allow for lasting cooperation and holding of the insert 2 inside a floating device 1 according to the invention, a floating device 1 of this kind further comprises fixing means (not shown in the drawings). Fixing means of this kind are advantageously reversible, i.e. they ensure that said insert 2 is exchangeable after installation thereof. However, fixing means of this kind are arranged so as to maintain a relative position of said floating device 1 along the insert 2 and to enclose all or part of said insert 2. Advantageously, but in a non-limiting manner, fixing means of this kind for a floating device according to the invention may comprise a plurality of bolts or any other suitable equipment. Once installed inside said floating device 1, the insert 2 is then advantageously maintained by gravitational force and by the presence of said bolts. In a variant or in addition, bolts of this kind may advantageously be replaced by supports or any other fixing means capable of carrying out the attachment and holding function. Moreover, it is possible that the insert 2 and the floating device 1 may be mutually arranged, on account of the structures thereof, to cooperate and to hold together. By way of non-limiting example, the floating device 1 and the insert 2 may comprise shoulders, said shoulders being mutually arranged such that the insert 2 bears on the floating device 1 in the region of the shoulders thereof, simply by means of gravitational force.

In a variant or in addition, when the application implemented by a floating system according to the invention requires the use of fluid pipes for adequate operation, according to an embodiment described with reference to FIG. 2A to 2C, a floating device 1 according to the invention may comprise one or more secondary ports. In a manner similar to a main port Lp, the secondary port or ports extend as “ports” or openings, recesses or cavities that lead into or are not arranged in the floating device in order to allow passage thereto, and indeed to allow for the holding of fluid pipes or any other cables necessary for implementing the desired application or services. In a manner similar to a main port Lp, when provided on the device floating 1, each secondary port Ls also comprises an axis Als, respectively, that is substantially in parallel with the longitudinal axis Alp of the main port Lp. By way of non-limiting example, secondary ports Ls of this kind are advantageously arranged so as to each accommodate fluid pipes 3. Within the context of the preferred application in conjunction with an electrical energy production system based on OTEC technologies, secondary ports Ls of this kind may advantageously be provided in the body of the device in order to receive, for example, means for drawing and/or returning cold and/or warm water, in the form of pipes. Pipes of this kind could also, in a variant or in addition, cooperate with the outer wall of the floater, by means of one or more fastenings, or by any other equivalent means for ensuring the fixing thereof. According to a preferred but non-limiting arrangement, described in particular with reference to FIG. 2A to 2C, two secondary ports Ls may be provided in the floating device 1 according to the invention. Furthermore, when the floater of a floating device 1 according to the invention approximates a hollow cylinder or a hollow ring, in view of the main port Lp, each secondary port Ls may be arranged such that said secondary ports each comprise longitudinal axes that are in parallel with the axis of revolution of the main port if said main port has a circular cross section. Said longitudinal axes Alp and Als of said different main secondary port(s) may each be perpendicular to a diameter of a cross section of said floater of a floating device 1 according to the invention. Longitudinal axes Als and Alp of this kind are generally substantially vertical after the device 1 has been placed in the water. Moreover, according to an embodiment of a floating device 1 according to the invention, the secondary ports Ls may be arranged on either side of the main port Lp.

Furthermore, in order to prevent drifting of a floating device 1 according to the invention, an anchoring system is generally implemented. In addition, the floating device 1 according to the invention may furthermore advantageously comprise or cooperate with anchoring means that cooperate with the floater by means of an optionally reversible fitted connection. Depending on the geomorphology of the installation site or sites of a floating device and a floating system according to the invention, the anchoring means of said floating device may advantageously be arranged so as to moor a floating device of this kind at one or more desired depths. Advantageously, the anchoring means of a floating device of this kind may comprise at least one mooring line 4. In order to optimize the stability of a floating device according to the invention, the anchoring means thereof may preferably comprise six to eight mooring lines, although the number of mooring lines in no way limits the invention. Mooring lines of this kind may be formed of chains, steel cables or polymer cables, a combination of said elements, or any other element capable of ensuring the use of a preferred element for the benefit of another, depending on the sea conditions.

According to a second object, the invention also provides a floating system 20 comprising a floating device 1 according to the first object of the invention and an insert 2 that cooperates with said floating device 1 by means of an advantageously reversible fitted connection. Within the context of the preferred but non-limiting application, said insert 2 is advantageously designed to produce electrical energy using a temperature gradient or heat transfer, on the basis of OTEC technologies. Within this application context, a floating system 20 of this kind may advantageously and commonly be denoted a floating OTEC. FIG. 2A to 2C show a non-limiting embodiment of a floating system of this kind. The insert 2 of said system represents the center of the system 20, designed to allow for rapid installation of said system and to facilitate the maintenance processes. An insert 2 of this kind is preferably substantially cylindrical in shape. Nonetheless, the invention is not limited to this one shape, the shape advantageously depending on the desired application or services. According to this advantageous embodiment, the outside diameter of the cross section of the insert 2 may advantageously be selected so as to be between two meters and fifteen meters, and the height of said cylinder may be between two and twenty meters. Nonetheless, the invention is not limited to just these value ranges or to this circular design, and generally depends on the desired application or services.

An electrical energy production system 20 of this kind preferably uses OTEC technologies, consisting primarily in methods using a temperature gradient that exists between cold deep seawater and tropical warm surface seawater, in order to produce electricity without carbon emissions. In order to achieve this, said insert 2 is arranged so as to implement closed-cycle OTEC technology. FIG. 4 schematically shows a non-limiting example of the structure of the insert 2 of a floating system according to the invention, which system is arranged so as to produce electrical energy.

For this purpose, in order to operate an electrical energy production system 20 of this kind, the insert 2 of a floating system 20 according to the invention may, in a non-limiting manner, comprise a first supply circuit for warm water WW comprising one or more first pumps 110 and a first warm water intake WWI that cooperates with said first pumps 110. A first warm water WW supply circuit of this kind, denoted by a plurality of continuous solid lines, makes it possible to achieve fluid communication among all the elements contained in said first supply circuit and to convey the warm water WW to the electrical energy production system. In an analogous manner, the insert 2 may comprise a second supply circuit for cold water CW comprising one or more second pumps 190 and a second cold water intake CWI that cooperates with said second pumps 190. A second cold water CW supply circuit of this kind, denoted by a plurality of dotted solid lines, makes it possible to achieve fluid communication among all the elements contained in said second supply circuit and to convey the cold water CW to the electrical energy production system. As mentioned above, said first and second supply circuits for warm water WW and for cold water CW comprise a first warm water intake WWI and a second cold water intake CWI, respectively. Respective first and second warm water intakes WWI and cold water intakes CWI of this kind make it possible to convey cold water and warm water to the respective supply circuits thereof and may advantageously be embodied in the form of a plurality of pipes (also referred to as “intake pipes”) which are advantageously and mainly formed of high-density polyethylene. Since the first warm water intake CWI is positioned in the surface water, the holding thereof may be complex in some cases owing to the presence of water flows and waves. In order to ensure the stability of said intake and to limit the displacement thereof, a first warm water intake CWI of this kind may also comprise or cooperate with one or more suitable ballast and/or buoyancy means. The dimensions of the second cold water intake CWI are advantageously arranged so as to be able to convey cold water from a sufficient depth, for example seven hundred or one thousand meters deep, in order that said cold water CW that is drawn is at a temperature of approximately four to seven degrees Celsius.

Furthermore, the insert 2 of a floating system 20 of this kind according to the invention may also comprise a supply circuit for operating fluid WF, said circuit comprising a supply circuit for operating fluid WF comprising a circulation pump 130 for said operating fluid WF. By way of non-limiting example, in order to provided sufficient pressure to the system in order to generate electrical energy while using non-hazardous coolant fluids, which optionally also take account of issues of global warming, an operating fluid WF of this kind preferably and mainly consists of 1,1,1,2-tetrafluoroethane, since this is non-inflammatory and non-toxic. The operating fluid WF supply circuit, which is advantageously closed, is denoted in FIG. 4 by a plurality of discontinuous, close solid lines and makes it possible to achieve fluid communication among all the elements contained in said supply circuit and to circulate the operating fluid WF inside the electrical energy production system 20.

Moreover, in order to implement the closed cycle of the electrical energy production system contained within the insert 2, said insert may also comprise a first heat exchanger 120 that cooperates fluidically, i.e. is in fluid communication, with said first warm water WW supply circuit and said operating fluid WF supply circuit. The warm water WW, advantageously drawn from the surface at a temperature of approximately twenty-five to thirty-five degrees Celsius, is conveyed to the first heat exchanger 120 by means of the first supply circuit. The warm water WW then circulates through the first heat exchanger 120 and transfers its heat, in the form of calories, in order to bring the operating fluid WF to boiling point, said operating fluid transitioning to the vaporous state. As a result, the first heat exchanger 120, also referred to as the evaporator, advantageously makes it possible to transfer thermal energy, in the form of heat, from the warm water WW to the operating fluid WF, via an exchange surface that ensures separation between the warm water WW and the operating fluid WF. It is this transfer of thermal energy or heat which allows for the vaporization of said operating fluid WF. By way of a preferred but non-limiting example, the first heat exchanger 120 may advantageously consist of a plate exchanger, also known as a “plate heat exchanger” or “gasket type heat exchanger.” Said first heat exchanger, advantageously a plate exchanger or an exchanger comprising any other exchanger technology that ensures the efficiency of the system 20, may comprise plates that are preferably formed of titanium, in order to guarantee a long service life of said heat exchanger.

Subsequently, the operating fluid WF, in the form of vapor, expands while passing through one, or optionally a plurality of, turbine(s) that drive one or more generators in order to finally generate electrical energy. The floating electrical energy production system may also comprise a turbine 140 that cooperates fluidically, i.e. is in fluid communication, with the first heat exchanger 120 as a result of the operating fluid WF. Preferably, but in a non-limiting manner, a turbine 140 of this kind consists of a single axial impulse type turbine, optionally provided with means for partial admission (not shown in FIGS. 3A and 3B) of operating fluid WF vapor, said partial admission means making it possible to control the output power of the turbine. The kinetic energy of the operating fluid WF in the form of vapor makes it possible to rotate the blades, on which the action of the operating fluid WF is exerted, and a shaft S, said blades being located inside said turbine 140. Thermal energy is thus converted into mechanical energy. All or a portion of said mechanical energy can then be converted into electrical energy. In order to achieve this, the floating electrical energy production system may comprise an electricity generator 150 that cooperates with said turbine 140 by means of a mechanical connection. As a result, the turbine 140 and the electricity generator 150 of the electrical energy production system may be connected and form one single unit, said unit commonly being referred to as a “turbogenerator” or “turboalternator.”

Subsequently, since the electrical energy production system operates in a closed cycle, the operating fluid WF vapor is again condensed to a liquid in order to finally be recycled within said electrical energy production system. In order to achieve this, said electrical energy production system 20 may also comprise a second heat exchanger 180 that cooperates fluidically, i.e. is in fluid communication, with said second cold water CW supply circuit and said operating fluid WF supply circuit. The cold water CW, advantageously drawn from depths of approximately seven hundred to one thousand meters at a temperature of approximately four to seven degrees Celsius, is conveyed to the second heat exchanger 180 by means of the second supply circuit. The cold water CW then circulates through the second heat exchanger 180 and transfers its heat energy in order to condense the operating fluid WF, said operating fluid transitioning from the gaseous state to the liquid state. As a result, the second heat exchanger 180, also referred to as the condenser, advantageously makes it possible to transfer thermal energy from the cold water CW to the operating fluid WF, via an exchange surface that ensures separation between the cold water CW and the operating fluid WF. It is this transfer of thermal energy which allows for the condensation of said operating fluid WF. Advantageously but in a non-limiting manner, similarly to the first heat exchanger 120, a second heat exchanger 180 of this kind may consist of a double walled heat exchanger. By way of a preferred but non-limiting example, the second heat exchanger 180 may consist of a plate exchanger (also known as a “plate heat exchanger” or “gasket type heat exchanger”).

Once the operating fluid WF is again in the liquid state, a cycle of electrical energy production via the production system 20 is again carried out. The warm water WW and the cold water CW, in turn, are then conveyed to the outside of the system since the respective temperatures thereof are not sufficient to supply the first and second heat exchangers 120, 180 in order to vaporize and condense, respectively, the operating fluid WF. For this purpose, the electrical energy production system 20 may comprise a water outlet WO that cooperates fluidically, i.e. is in fluid communication, with the first and second heat exchangers 120 and 180.

Owing to the structure and the functions thereof, a floating system 20 for generating electrical energy, according to the invention, is designed to preferably receive a turbine 150 that is capable of producing electricity E₁ at a power of between two and three megawatt hours. Nonetheless, the invention is not limited to just this range of power values. Said system may advantageously be adapted so as to be capable of producing powers of between two hundred kilowatt hours and five megawatt hours.

As already specified according to an embodiment described with reference to FIG. 2A to 2C, a floating device 1 according to the invention may advantageously comprise two secondary ports Ls that are arranged, optionally on either side of the main port Lp, so as to accommodate fluid pipes, more particularly water pipes 3. Within the context of an electrical energy generation system, water pipes make it possible to intake and discharge water, more particular warm water WW and/or cold water CW, that is required for said system 20 to operate. In addition, the first and second supply circuits for warm water WW and cold water CW, respectively, of an electrical energy production system may comprise water pipes, at least one of said pipes being accommodated inside a secondary port Ls of said floating device 1. According to a non-limiting example, the water pipe consisting of a warm water intake is located at a shallow depth. Said pipe can thus advantageously be positioned in the region of the insert 2 or even along the floater of the floating device 1.

The water pipe consisting of the cold water intake, in turn, may advantageously be formed primarily of high-density polyethylene (also known by the abbreviation HDPE), because a material of this kind has excellent bending properties and a low density, making it possible to reduce the strain applied on said pipe. However, the invention is not limited to just this material, because the water pipe consisting of the cold water intake may optionally be formed from other materials without limiting the invention. In an analogous manner, the invention is not limited to the use of just one pipe for warm water intake or cold water intake, respectively. A floating system 20 according to the invention may optionally comprise a plurality of water pipes consisting of a plurality of warm water and/or cold water intakes. In an analogous manner, said pipe consisting of the cold water intake can thus advantageously be positioned on or under the insert 2 or even along the floating device 1. The movement of the pipe is certainly one of the main problems encountered at depth. A movement of this kind is generally directly cause by the movements of the floating device, thus generating harmful stresses in the water pipe consisting of the cold water intake. In order to limit, or even to entirely eliminate, this phenomenon, while in particular reducing the stress variations, the water pipe consisting of the cold water intake may optionally comprise or cooperate with ballast means.

A floating system 20 according to the invention may also comprise an additional pipe consisting of a cold water discharge means. An additional pipe of this kind can advantageously be positioned on the insert 2, opposite the water pipe consisting of the cold water intake. In an analogous manner, the water pipe consisting of the cold water return means can advantageously be formed primarily of high-density polyethylene and be of a length of between one hundred and two hundred-and-fifty meters.

Finally, a floating system 20 according to the invention may also comprise means for exporting electricity E₁ which make it possible to transport the electricity to land or more generally to the site to which electricity is intended to be supplied. Exportation or carrier means of this kind may advantageously comprise one or more power cables that are independent or optionally positioned and/or fastened along a mooring line or along a water pipe that provides the cold water intake. Preferably, but in a non-limiting manner, the exportation means can be stabilized in the region of the sea bed as far as a coastal zone or even up to another floater.

The invention has been described with reference to the use and/or application thereof in conjunction with electrical energy production for, for example, a hotel complex located in an isolated island archipelago. Said invention may also be carried out for any other category of location, for example isolated communities, government and/or military facilities, large industrial and/or commercial sites, universities, airports or even data-centers that are capable of carrying out “OTEC”-type technologies, i.e. in any part of the world where the required temperature difference, i.e. in the region of twenty degrees Celsius, between a warm source and a cold source, exists throughout the year, typically in tropical waters.

It is also conceivable for the device and system according to the invention to ensure other functions and/or applications than those described and/or mentioned above, in particular preferably the production of electrical energy using a temperature gradient. The invention is not limited to the application within which the device and system according to the invention are used.

Other modifications are also conceivable, without departing from the scope of the present invention defined by the accompanying claims.

1. Floating device for cooperating with an insert by means of a reversible fitted connection, comprising a floater and having a main port, wherein:
the main port is arranged so as to receive said insert, said main port having a cross section that is larger than or substantially equal to the cross section of the outer wall of the casing of a portion of said insert and having a longitudinal axis that is substantially perpendicular to the waterline of said device once said device is in the water;
said device furthermore comprises reversible attachment elements that are arranged so as to maintain a relative position of said device along the insert.

2. Floating device according to claim 1, wherein the casing or the structure of said floater is formed primarily of steel and/or polymer.

3. Floating device according to claim 1, wherein said floater is formed of a plurality of separate elements that cooperate, respectively, in pairs, by means of a mechanical connection of the fitted type.

4. Floating device according to claim 1, wherein the floater is formed of a plurality of compartments that cooperate, respectively, in pairs, by means of a connection of the fitted type.

5. Floating device according to claim 1, wherein the casing of said device has a skirt-type structure.

6. Floating device according to claim 1, wherein the attachment elements include bolts.

7. Floating device according to claim 1, comprising a secondary port that has an axis that is substantially in parallel with the longitudinal axis of the main port and is arranged so as to accommodate a water pipe.

8. Floating device according to claim 1, further comprising an anchoring device.

9. Floating device according to claim 1, wherein the anchoring device comprises at least one mooring line.

10. Floating system comprising a floating device according to claim 1 and an insert that cooperates with said floating device by means of a reversible fitted connection, said insert being configured to produce electrical energy using the temperature gradient of the oceans.

11. Floating system according to the claim 10, wherein the insert comprises:
first and second supply circuits for warm water and cold water, respectively;
a supply circuit for operating fluid;
first and second heat exchangers that cooperate fluidically with said first and second supply circuits for warm water and cold water, respectively, and with said supply circuit for operating fluid;
a turbine that cooperates fluidically with the first and second heat exchangers;
an electricity generator that cooperates with said turbine by means of a mechanical connection.

12. Floating system comprising a floating device according to claim 7, and an insert that cooperates with said floating device by means of a reversible fitted connection, said insert being configured to produce electrical energy using the temperature gradient of the oceans.

13. Floating system according to claim 12, wherein the insert comprises:
first and second supply circuits for warm water and cold water, respectively;
a supply circuit for operating fluid;
first and second heat exchangers that cooperate fluidically with said first and second supply circuits for warm water and cold water, respectively, and with said supply circuit for operating fluid;
a turbine that cooperates fluidically with the first and second heat exchangers;
an electricity generator that cooperates with said turbine by means of a mechanical connection.

14. Floating system according to claim 13, wherein the first and second supply circuits for warm water and cold water, respectively, comprise water pipes, at least one of said pipes being accommodated inside the secondary port of said floating device.
